(19) United States
(12) Patent Application Publication
(10) Pub. No.: US 2020/0165848 A1
(43) Pub. Date: May 28, 2020

(54) VEHICLE DOOR CONTROL DEVICE

(71) Applicant: Toyota Jidosha Kabushiki Kaisha, Toyota-shi Aichi-ken (JP)

(72) Inventor: Tatsuya Shimizu, Okazaki-shi (JP)

(73) Assignee: Toyota Jidosha Kabushiki Kaisha, Toyota-shi Aichi-ken (JP)

(21) Appl. No.: 16/695,930

(22) Filed: Nov. 26, 2019

(30) Foreign Application Priority Data
Nov. 28, 2018 (JP) 2018-222609

(51) Int. Cl. E05C 17/00; E05B 81/56; E05B 81/64; E05C 17/20; E05C 17/22; B60Q 9/00

(52) U.S. Cl. CPC E05C 17/006; E05B 81/56; E05B 81/64; E05C 17/203; E05Y 2201/232; B60Q 9/00; E05Y 2900/531; E05Y 2201/21; E05C 17/22

(57) ABSTRACT

A vehicle door control device includes a door braking unit configured to brake opening-closing operation of a door in a vehicle; a door forcibly stopping unit configured to forcibly and mechanically stop the opening-closing operation of the door, an obstacle detection unit configured to detect an obstacle that exists around the vehicle or approaches the vehicle; and a control unit configured to operate the door braking unit and further operate the door forcibly stopping unit according to a status of the opening-closing operation of the door when the obstacle detection unit detects the obstacle.

### CROSS-REFERENCE TO RELATED APPLICATIONS

This application claims priority to Japanese Patent Application No. 2018-222609 filed on Nov. 28, 2018, which is incorporated herein by reference in its entirety including the specification, drawings and abstract.

### BACKGROUND

### 1. Technical Field

The disclosure relates to a vehicle door control device.

### 2. Description of Related Art

The disclosure relating to a vehicle door opening-closing control device is disclosed in Japanese Patent Application Publication No. 2009-143251 (JP 2009-143251 A). This vehicle door opening-closing control device measures a distance between a vehicle and an adjacent object, and calculates an angle at which a door can be opened based on the distance. Then, when the door is opened, opening-closing operation of the door is gradually braked within the openable angle, so as to limit the opening of the door. Thus, it is possible to restrain the opened door from coming into contact with the adjacent object.

### SUMMARY

However, with regard to the vehicle door control device disclosed in JP 2009-143251 A, when an external force equal to or greater than a braking force is exerted in a state where the braking force is exerted to stop the door, the door may come into contact with the adjacent object. Thus, the above-described related art has room for improvement in terms of this point.

The disclosure provides a vehicle door control device capable of reliably preventing a door from coming into contact with an obstacle at the time of opening-closing of the door.

An aspect of the disclosure relates to a vehicle door control device including a door braking unit configured to brake opening-closing operation of a door in a vehicle; a door forcibly stopping unit configured to forcibly and mechanically stop the opening-closing operation of the door; an obstacle detection unit configured to detect an obstacle that exists around the vehicle or approaches the vehicle; and a control unit configured to operate the door braking unit and further operate the door forcibly stopping unit according to a status of the opening-closing operation of the door when the obstacle detection unit detects the obstacle.

With the above configuration, the vehicle door control device includes the door braking unit, the door forcibly stopping unit, the obstacle detection unit, and the control unit. The door braking unit brakes the opening-closing operation of the door in the vehicle. Meanwhile, the door forcibly stopping unit forcibly and mechanically stops the opening-closing operation of the door. The control unit operates the door braking unit to brake the opening-closing operation of the door when an obstacle that exists around the vehicle or approaches the vehicle is detected by the obstacle detection unit. Thus, it is possible to restrain the door from coming into contact with the obstacle. In addition, the control unit further operates the door forcibly stopping unit according to the status of the opening-closing operation of the door. Thus, even in the case where opening-closing of the door is not stopped by the door braking unit, it is possible to reliably stop the door and to restrain the door from coming into contact with the obstacle.

The vehicle door control device according to the above aspect exhibits an effect of reliably preventing the door from coming into contact with the obstacle at the time of opening-closing of the door.

In the vehicle door control device according to the above-aspect, the control unit may be configured to operate the door braking unit such that a braking force is gradually increased as a distance between the door and the obstacle is decreased when the door is opened.

With the above configuration, the control unit causes the door braking unit to gradually increase the braking force as the distance between the door and the obstacle is decreased when the door is opened. Accordingly, it is possible to restrain the door from coming into contact with the obstacle while reducing an operation load on an occupant at the time when the occupant starts opening the door.

The vehicle door control device having the above configuration exhibits a superior effect of improving operability of the door at the time of opening-closing of the door.

In the vehicle door control device according to the above-aspect, the control unit may be configured to increase the braking force of the door braking unit stepwise.

With the above configuration, the control unit causes the door braking unit to increase the braking force stepwise. Accordingly, in the case where the obstacle is detected, the occupant who operates the door can easily recognize that the braking force is exerted on the door. That is, in the case where it is difficult to open or close the door, the occupant can easily determine whether the difficulty in opening-closing of the door is caused by the operation of the vehicle door control device due to the obstacle nearby, or the difficulty is caused by a failure or the like of an opening-closing mechanism of the door.

The vehicle door control device having the above configuration exhibits a superior effect of improving usability.

In the vehicle door control device according to the above-aspect, the control unit may be configured to operate the door forcibly stopping unit in a case where opening-closing of the door is not stopped in a state where a braking force of the door braking unit is at a maximum.

With the above configuration, in the case where opening-closing of the door is not stopped in the state where the braking force of the door braking unit is at the maximum, the control unit operates the door forcibly stopping unit. Thus, even in the case where an external force is exerted on the door such that opening-closing of the door cannot be stopped when the door braking unit is operated, the door forcibly stopping unit can forcibly and mechanically stop the opening-closing of the door.

The vehicle door control device having the above configuration exhibits a superior effect of further reliably preventing the door from coming into contact with the obstacle at the time of opening-closing of the door.

In the vehicle door control device according to the above-aspect, the obstacle detection unit may be configured to further detect the obstacle that approaches the vehicle from behind.

With the above configuration, the obstacle detection unit further detects the obstacle that approaches the vehicle from behind. Thus, even in the case where the occupant opens the door without noticing the obstacle that approaches the vehicle from behind, it is possible to restrain the door from coming into contact with the obstacle.

The vehicle door control device having the above configuration exhibits the superior effect of further reliably preventing the door from coming into contact with the obstacle at the time of opening-closing of the door.

In the vehicle door control device according to the above-aspect, the obstacle detection unit may be configured to further detect the obstacle that exists on an opening-closing locus of the door.

With the above configuration, the obstacle detection unit further detects the obstacle that exists on the opening-closing locus of the door. Thus, it is possible to restrain the door from coming into contact with the obstacle at the time of opening-closing of the door.

The vehicle door control device having the above configuration exhibits the superior effect of further reliably preventing the door from coming into contact with the obstacle at the time of opening-closing of the door.

In the vehicle door control device according to the above-aspect, after the control unit operates at least one of the door braking unit and the door forcibly stopping unit to stop the opening-closing operation of the door, the control unit may stop operation of the at least one of the door braking unit and the door forcibly stopping unit after a lapse of a specified time since the opening-closing operation of the door is stopped.

With the above configuration, after the control unit operates at least one of the door braking unit and the door forcibly stopping unit to stop the opening-closing operation of the door, the control unit stops operation of the at least one of the door braking unit and the door forcibly stopping unit (i.e., stops operation of the at least one of the door braking unit and the door forcibly stopping unit, which is/are operated) after a lapse of a specified time since the opening-closing operation of the door is stopped. Accordingly, after the lapse of the specified period since the door becomes unable to be operated, the door can be operated. Thus, the occupant can continue to cause the door to perform the opening-closing operation when necessary.

The vehicle door control device having the above configuration exhibits a superior effect of respecting the occupant's intention at the time of opening-closing of the door (i.e., a superior effect of allowing the occupant to operate the door based on the occupant's intention).

In the vehicle door control device according to the above-aspect, the control unit may be configured to operate a warning unit that issues a warning when stopping the operation of the at least one of the door braking unit and the door forcibly stopping unit.

With the above configuration, the control unit is configured to operate a warning unit that issues a warning when stopping the operation of the at least one of the door braking unit and the door forcibly stopping unit (i.e., stopping the operation of the at least one of the door braking unit and the door forcibly stopping unit, which is/are operated). As a result, the occupant can recognize that the braking force exerted on the door is lost and care is needed in opening-closing of the door.

The vehicle door control device having the above configuration exhibits a superior effect of improving safety.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic side view illustrating a door of a vehicle including a vehicle door control device according to a first embodiment and a part of a vehicle body near the door;

FIG. 2 is a schematic plan view illustrating a state where main portions of the vehicle door control device according to the first embodiment are seen from above the vehicle;

FIG. 3A is a schematic sectional view illustrating a state of a door forcibly stopping unit before the door forcibly stopping unit is operated, and FIG. 3B is a schematic sectional view illustrating a state of the door forcibly stopping unit at a time when the door forcibly stopping unit is operated, as compared to FIG. 3A;

FIG. 4 is a sectional view taken along line IV-IV in FIG. 1;

FIG. 5 is a block diagram illustrating a hardware configuration of the vehicle door control device according to each of the first and a second embodiments;

FIG. 6 is a block diagram illustrating a functional configuration of the vehicle door control device according to each of the first and second embodiments;

FIG. 7 is a flowchart illustrating an operation procedure of the vehicle door control device according to the first embodiment; and

FIG. 8 is a flowchart illustrating an operation procedure of the vehicle door control device according to the second embodiment.

### DETAILED DESCRIPTION OF EMBODIMENTS

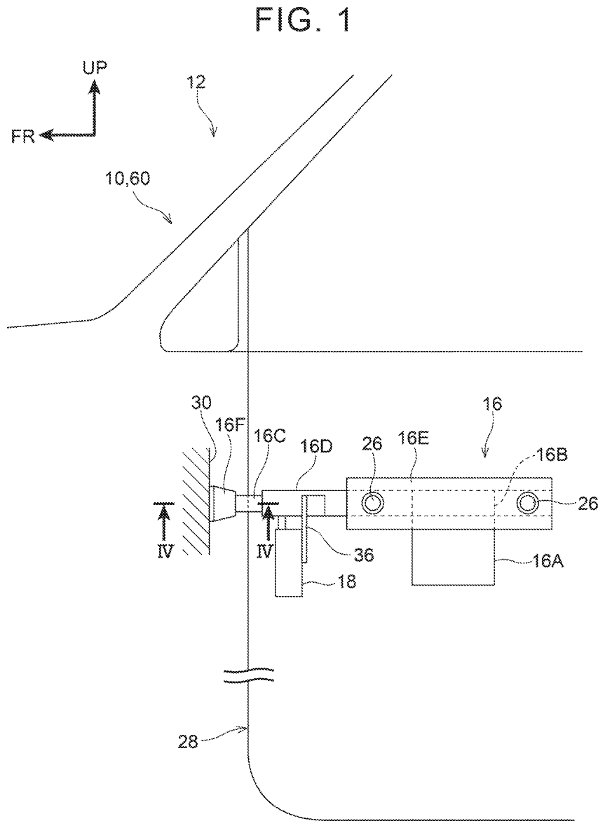

Hereinafter, a description will be provided on a vehicle door control device according to a first embodiment of the disclosure with reference to FIG. 1 to FIG. 7. Note that the same or equivalent components in the drawings are denoted by the same reference numerals and symbols. In addition, dimension ratios in the drawings may be exaggerated for convenience of the description and may differ from actual ratios.

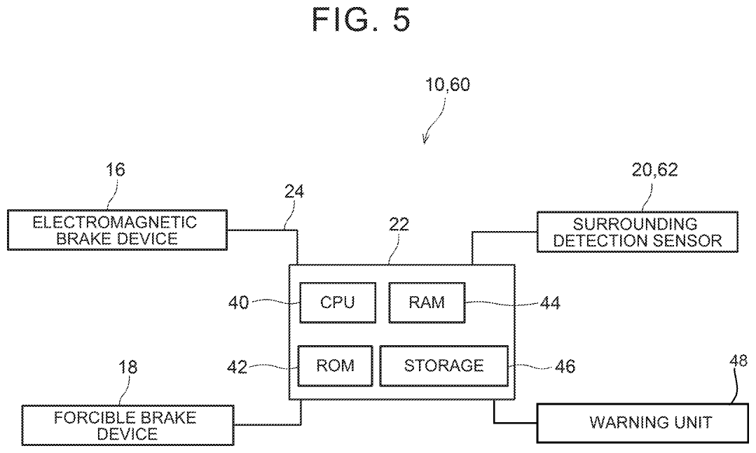

FIG. 5 is a block diagram illustrating a hardware configuration of a vehicle door control device 10. As illustrated in FIG. 5, the vehicle door control device 10 includes an electromagnetic brake device 16 that is an example of a door braking unit mounted on a vehicle 12 (see FIG. 1); a forcible brake device 18 that is an example of a door forcibly stopping unit; a surrounding detection sensor 20 that is an example of an obstacle detection unit; and a control unit 22, such as an electronic control unit, that is an example of a control unit. The components are connected to each other via a bus 24 so that the components can communicate with each other.

As illustrated in FIG. 1, the electromagnetic brake device 16 is configured to include an electromagnetic brake body 16A, a deceleration pinion gear section 16B, a rack gear 16C, a gear cover 16D, a door attachment bracket 16E, and a body attachment bracket 16F. The electromagnetic brake body 16A is attached to the inside of a door 28 via the door attachment bracket 16E that is attached to the inside of the door 28 by a fastening section 26. The deceleration pinion gear section 16B, which is engaged with the rack gear 16C, is attached to this electromagnetic brake body 16A. When the electromagnetic brake body 16A is operated, the electromagnetic brake body 16A applies a braking force to the deceleration pinion gear section 16B. Note that the electromagnetic brake body 16A can vary the braking force stepwise by varying at least one of an electric current and a voltage.

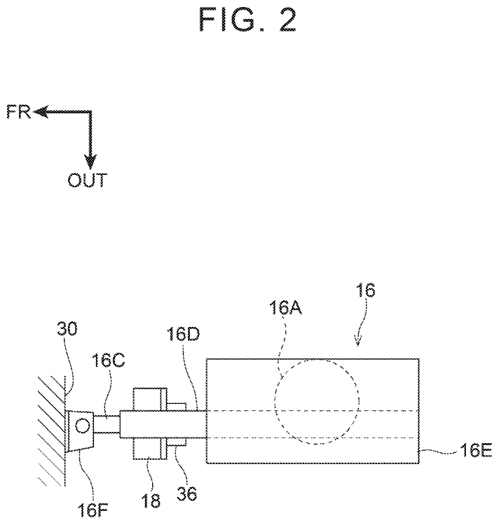

The rack gear 16C has a substantially columnar shape that extends in a substantially vehicle front-rear direction. An end portion at a front side of the rack gear 16C in the vehicle front-rear direction is fixed to a vehicle body 30 via the body attachment bracket 16F. This end portion at the front side in the vehicle front-rear direction is attached to the body attachment bracket 16F so as to be rotatable with a substantially vehicle up-down direction being a direction of an axis (i.e., so as to be rotatable about an axis extending in a substantially vehicle up-down direction) (see FIG. 2).

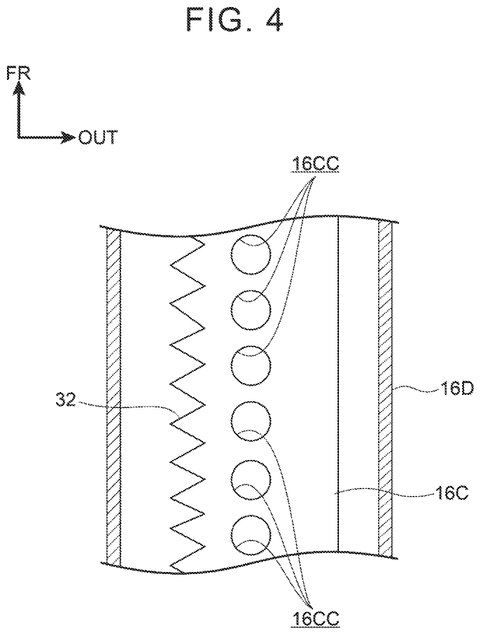

An end portion at a rear side of the rack gear 16C in the vehicle front-rear direction is inserted in the substantially cylindrical gear cover 16D that is fixed to the door attachment bracket 16E. Thus, along with opening-closing of the door 28, the rack gear 16C makes relative movement in the gear cover 16D (i.e., the rack gear 16C moves in the gear cover 16D relative to the gear cover 16D) while rotating about the body attachment bracket 16F. In addition, as illustrated in FIG. 4, a gear section 32 is formed on an inner surface of the rack gear 16C in a vehicle width direction, and the gear section 32 is engaged with the deceleration pinion gear section 16B. Thus, when the electromagnetic brake body 16A applies the braking force to the deceleration pinion gear section 16B, the movement of the rack gear 16C relative to the gear cover 16D and the door 28 is restricted. In this way, the opening-closing operation of the door 28 is braked. The term “opening-closing (operation) of the door” signifies “opening (operation) of the door” “closing (operation) of the door”, “operation of opening and then closing the door”, “operation of closing and then opening the door”, or the like according to a situation.

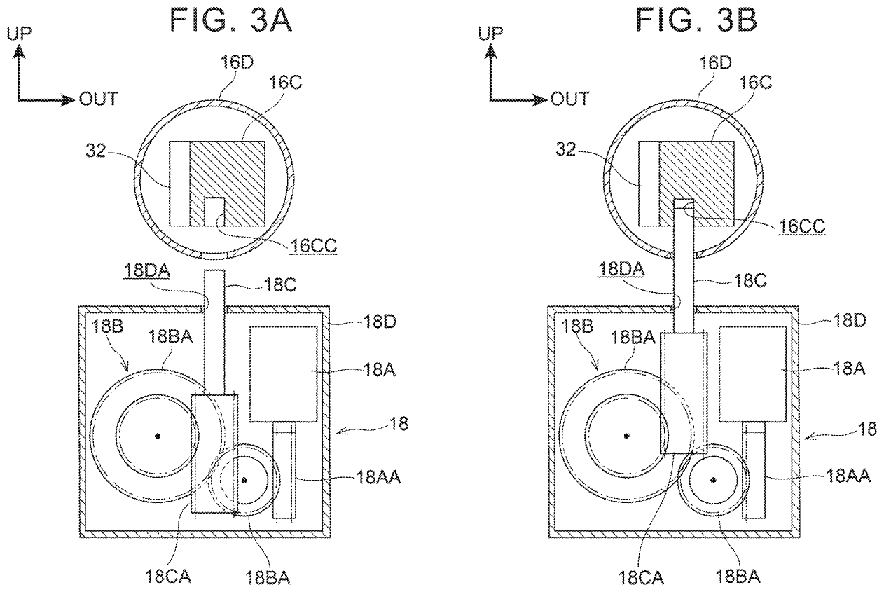

Locking holes 16CC are formed on a lower surface of the rack gear 16C in the vehicle up-down direction. This locking holes 16CC are provided at predetermined intervals along a longitudinal direction of the rack gear 16C. Each of the locking holes 16CC has a circular shape in a vehicle plan view and is recessed toward an upper side in the vehicle up-down direction (see FIG. 3A). In addition, the electromagnetic brake device 16 includes a Hall sensor (a Hall effect sensor), an encoder, and the like, which are not illustrated, and thus can detect a position and moving (opening-closing) speed of the door 28.

As illustrated in FIG. 1, the forcible brake device 18 is attached to the gear cover 16D via an attachment bracket 36 so as to be located below the gear cover 16D in the vehicle up-down direction. As illustrated in FIG. 3A, this forcible brake device 18 includes a motor 18A, a gear unit 18B, and a forcible brake pin 18C, and each of these components is stored in a box-shaped case 18D.

In an example, when the motor 18A is operated, the motor 18A causes a worm gear 18AA to rotate. A direction of axis (i.e., an axial direction) of the worm gear 18AA is the vehicle up-down direction, and the worm gear 18AA is engaged with the gear unit 18B.

The gear unit 18B includes a plurality of gears 18BA. The gear unit 18B transmits a rotational force of the motor 18A, which has been transmitted to the gear unit 18B through the worm gear 18AA, to a gear 18CA (described below) of the forcible brake pin 18C.

An axial direction of the forcible brake pin 18C is the vehicle up-down direction. The forcible brake pin 18C has a columnar shape such that a diameter dimension thereof (radial dimension thereof) is smaller than a diameter dimension of the locking hole 16CC in the rack gear 16C. The gear 18CA is attached to a lower end portion of the forcible brake pin 18C. Meanwhile, an upper portion of the forcible brake pin 18C extends through a through-hole 18DA formed on an upper surface of the case 18D, and is projected to the outside of the case 18D. When the rotational force of the motor 18A is transmitted to the forcible brake pin 18C via the gear unit 18B, as illustrated in FIG. 3B, the forcible brake pin 18C moves to the upper side in the vehicle up-down direction and is inserted in one of the locking holes 16CC of the rack gear 16C.

As illustrated in FIG. 5, the surrounding detection sensor 20 is a sensor that detects a surrounding situation around the vehicle 12, and includes a laser radar, an ultrasonic sensor, a millimeter-wave radar (none of them is illustrated), or the like, for example. The surrounding detection sensor 20 may be configured by combining a plurality of sensors. In addition, the surrounding detection sensor 20 may include a camera and detect the surrounding situation around the vehicle 12 by image recognition with the use of the camera.

The control unit 22 includes a central processing unit (CPU) 40, read only memory (ROM) 42, random access memory (RAM) 44, and a storage 46 that are provided therein.

The CPU 40, which is a central processing unit, executes various programs, and controls each component. That is, the CPU 40 reads the program from the ROM 42 or the storage 46, and executes the program by using the RAM 44 as a work area. According to the program that is recorded in the ROM 42 or the storage 46, the CPU 40 executes control for each of the above components and various kinds of arithmetic processing. In this embodiment, a door opening-closing control program is stored in the ROM 42 or the storage 46.

The ROM 42 stores the various programs and various kinds of data. The RAM 44 serves as the work area, and temporarily stores the program or the data. The storage 46 includes a hard disk drive (HDD) or a solid state drive (SSD), and stores the various programs including an operating system as well as the various kinds of the data.

When executing the door opening-closing control program described above, the vehicle door control device 10 uses the above-described hardware resources to realize various functions. A description will now be provided on a functional configuration realized by the vehicle door control device 10.

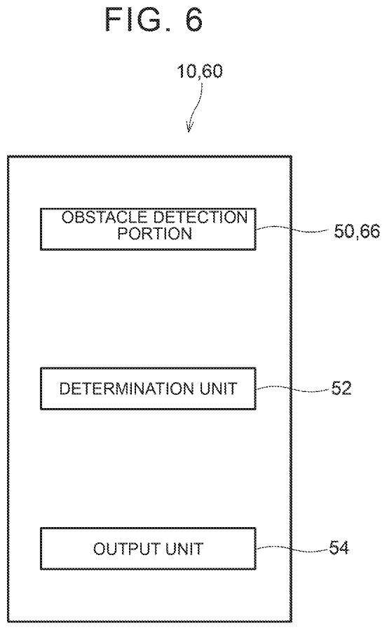

FIG. 6 is a block diagram illustrating an example of the functional configuration of the vehicle door control device 10.

As illustrated in FIG. 6, the vehicle door control device 10 includes, as the functional configuration, an obstacle detection portion 50, a determination unit 52, and an output unit 54. The functional configuration is realized when the door opening-closing control program, which is stored in the ROM 42 or the storage 46 (see FIG. 5) is read and executed by the CPU 40 in the control unit 22.

The obstacle detection portion 50 receives information on the surrounding situation around the vehicle 12 from the surrounding detection sensor 20 and determines presence or absence, a kind, a position, and the like of an obstacle around the vehicle 12, in particular, an obstacle that exists on an opening-closing locus (path) of the door 28, an obstacle that approaches the vehicle 12, and the like. The opening-closing locus (path) is registered in advance. The opening-closing locus (path) is a locus along which the door 28 moves when the door 28 is opened and closed.

The determination unit 52 receives information on an obstacle from the obstacle detection portion 50. In addition, in the case where the opening operation of the door 28 is performed when an obstacle is detected, the determination unit 52 detects a distance between the door 28 and the obstacle, and determines whether the distance is longer than a specified threshold. The determination unit 52 may determine that the opening operation of the door 28 is performed when a switch of a courtesy light, which is not illustrated, is turned on. In the case where the distance between the door 28 and the obstacle is shorter than the specified threshold, the determination unit 52 instructs the output unit 54 to brake the door opening-closing operation.

After instructing the output unit 54 to brake the opening-closing operation of the door 28, the determination unit 52 detects the distance between the door 28 and the obstacle. Then, after a specified time (for example, three seconds to five seconds) elapses in a state where the distance remains the same (the door 28 is stopped), the determination unit 52 instructs the output unit 54 to stop braking. At this time, the determination unit 52 also outputs a warning to the output unit 54.

Based on the information from the determination unit 52, the output unit 54 operates the electromagnetic brake device 16. When the output unit 54 operates the electromagnetic brake device 16, this electromagnetic brake device 16 is operated such that the braking force is increased stepwise (in three steps to five steps, for example). In addition, in the case where the door 28 moves in a direction to shorten the distance between the door 28 and the obstacle in a state where the electromagnetic brake device 16 is operated and generates the maximum braking force, the output unit 54 operates the forcible brake device 18.

Meanwhile, when the output unit 54 receives, from the determination unit 52, information indicating that braking should be stopped, the output unit 54 stops the operation of at least one (including both) of the electromagnetic brake device 16 and the forcible brake device 18 that is/are operated, and gives the warning to an occupant in a vehicle cabin via a warning unit 48. The warning is provided as alarm sound or the warning is displayed on an instrument panel, for example.

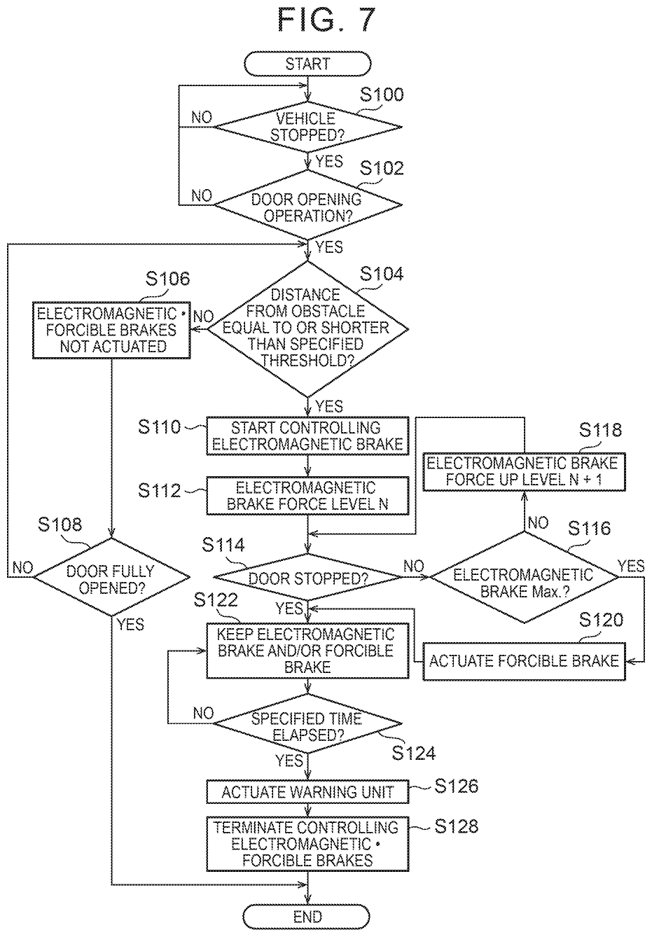

Next, a description will now be provided on the operation of the vehicle door control device 10. FIG. 7 is a flowchart illustrating an operation procedure of the vehicle door control device 10. When the CPU 40 reads the door opening-closing control program from the ROM 42 or the storage 46, loads the door opening-closing control program into the RAM 44, and executes the door opening-closing control program, opening-closing control for the door 28 is executed.

The CPU 40 determines whether the vehicle 12 is stopped (step S100). When the vehicle 12 is not stopped (step S100: NO), the CPU 40 repeats the processing in step S100. When the vehicle 12 is stopped (step S100: YES), the CPU 40 determines whether the opening operation of the door 28 is performed (step S102). When the opening operation of the door 28 is not performed (step S102: NO), the CPU 40 repeats the processing from step S100. When the opening operation of the door 28 is performed (step S102: YES), the CPU 40 detects the distance between the door 28 and an obstacle, and determines whether the distance is equal to or shorter than the specified threshold (step S104).

When the distance between the door 28 and an obstacle is longer than the specified threshold, that is, when an obstacle does not exist or when an obstacle is located at a position away from the door 28 and the opening-closing locus of the door 28 (step S104: NO), the CPU 40 does not operate (i.e., does not actuate) the electromagnetic brake device 16 and the forcible brake device 18 (step S106). Thereafter, the CPU 40 determines whether the door 28 is fully opened (step S108). When the door 28 is fully opened (step S108: YES), the CPU 40 terminates the processing. On the other hand, when the door 28 is not fully opened (step S108: NO), the CPU 40 repeats the processing from step S104.

When the distance between the door 28 and an obstacle is equal to or shorter than the specified threshold, that is, when an obstacle is located at the position near the door 28 or the opening-closing locus of the door 28 or at the position at which the obstacle interferes with the door 28 and the opening-closing locus of the door 28 (step S104: YES), the CPU 40 starts controlling the electromagnetic brake device 16 (step S110), and operates the electromagnetic brake device 16 such that the braking force of the electromagnetic brake device 16 in a desired step (a level N) is generated (step S112).

Next, the CPU 40 determines whether the door 28, which has been operated to be opened, is stopped (step S114). When the door 28 is stopped (step S114: YES), the CPU 40 keeps the electromagnetic brake device 16 in an operating state (step S1.22).

When the door 28 is not stopped (step S114: NO), the CPU 40 determines whether the braking force of the electromagnetic brake device 16 is at the maximum (step S116). When the braking force of the electromagnetic brake device 16 is not at the maximum (step S116: NO), the CPU 40 further increases the braking force of the electromagnetic brake device 16 by one step (level N+1) for braking (step S118), and thereafter repeats the processing from step S114. On the other hand, when the braking force of the electromagnetic brake device 16 is at the maximum (step S116: YES), the CPU 40 operates (i.e., actuates) the forcible brake device 18 (step S120), and keeps the forcible brake device 18 in an operating state (step S122).

Next, the CPU 40 determines whether the specified time has elapsed (step S124). When the specified time has not elapsed (step S124: NO), the CPU 40 repeats the processing in step S122. When the specified time has elapsed (step S124: YES), the CPU 40 issues the warning, i.e., actuates the warning unit 48 (step S126), and terminates the control for at least one (including both) of the electromagnetic brake device 16 and the forcible brake device 18 that is/or operated, that is, terminates the control processing (step S128). In this way, at least one of the electromagnetic brake device 16 and the forcible brake device 18, which is/are operated, is/are brought into a non-operating state, and the opening-closing operation of the door 28 can be performed.

Next, a description will be provided on the operation and effects in the first embodiment.

In this embodiment, as illustrated in FIGS. 3A, 3B, the vehicle door control device 10 includes the electromagnetic brake device 16, the forcible brake device 18, the surrounding detection sensor 20, and the control unit 22. The electromagnetic brake device 16 brakes the opening-closing operation of the door 28 in the vehicle 12. Meanwhile, the forcible brake device 18 forcibly and mechanically stops the opening-closing operation of the door 28. The control unit 22 brakes the opening-closing operation of the door 28 by operating the electromagnetic brake device 16 when an obstacle that exists around the vehicle 12 or approaches the vehicle 12 is detected by the surrounding detection sensor 20. Thus, it is possible to restrain the door 28 from coming into contact with the obstacle. In addition, the control unit 22 further operates the forcible brake device 18 according to a status of the opening-closing operation of the door 28. Thus, even in the case where opening-closing of the door 28 is not stopped by the electromagnetic brake device 16, it is possible to reliably stop the door 28 and restrain the door 28 from coming into contact with the obstacle. Therefore, it is possible to further reliably prevent the door 28 from coming into contact with obstacle at the time of the opening-closing of the door 28.

The control unit 22 causes the electromagnetic brake device 16 to gradually increase the braking force as the distance between the door 28 and an obstacle is decreased when the door 28 is opened. Accordingly, it is possible to restrain the door 28 from coming into contact with the obstacle while reducing an operation load on the occupant at the time when the occupant starts opening the door 28. Thus, it is possible to improve operability of the door 28 at the time of opening-closing of the door 28.

Furthermore, the control unit 22 causes the electromagnetic brake device 16 to increase the braking force stepwise. Accordingly, in the case where an obstacle is detected, the occupant who operates the door 28 can easily recognize that the braking force is exerted on the door 28. That is, in the case where it is difficult to open or close the door 28, the occupant can easily determine whether the difficulty in opening-closing of the door 28 is caused by the operation of the vehicle door control device 10 due to an obstacle nearby, or the difficulty is caused by a failure or the like of an opening-closing mechanism of the door 28. Thus, it is possible to improve usability.

Moreover, in the case where opening-closing of the door 28 is not stopped in the state where the braking force of the electromagnetic brake device 16 is at the maximum, the control unit 22 operates the forcible brake device 18. Thus, even in the case where an external force is exerted on the door 28 such that opening-closing of the door 28 cannot be stopped when the electromagnetic brake device 16 is operated, the forcible brake device 18 can forcibly and mechanically stop opening-closing of the door 28.

The surrounding detection sensor 20 also detects (i.e., further detects) an obstacle that exists on the opening-closing locus of the door 28. Thus, it is possible to restrain the door 28 from coming into contact with the obstacle at the time of opening-closing of the door 28. With the configuration described above, it is possible to further reliably prevent the door 28 from coming into contact with the obstacle at the time of opening-closing of the door 28.

After the control unit 22 operates at least one of the electromagnetic brake device 16 and the forcible brake device 18 to stop opening-closing of the door 28, the control unit 22 stops the operation of the at least one of the electromagnetic brake device 16 and the forcible brake device 18 (i.e., stops the operation of the at least one of the electromagnetic brake device 16 and the forcible brake device 18, which is/are operated) after the lapse of the specified time since the opening-closing of the door 28 is stopped. Accordingly, after the lapse of the specified period since the door 28 becomes unable to be operated, the door 28 can be operated again. Thus, the occupant can continue to cause the door 28 to perform the opening-closing operation when necessary. Thus, the occupant's intention at the time of opening-closing of the door 28 is respected (i.e., the occupant is allowed to operate the door 28 based on the occupant's intention).

When the control unit 22 stops the operation of at least one of the electromagnetic brake device 16 and the forcible brake device 18 that is/are operated, the control unit 22 operates the warning unit 48 that issues the warning. Thus, the occupant can recognize that the braking force exerted on the door 28 is lost and thus care is needed in opening-closing of the door 28. In this way, safety can be improved.

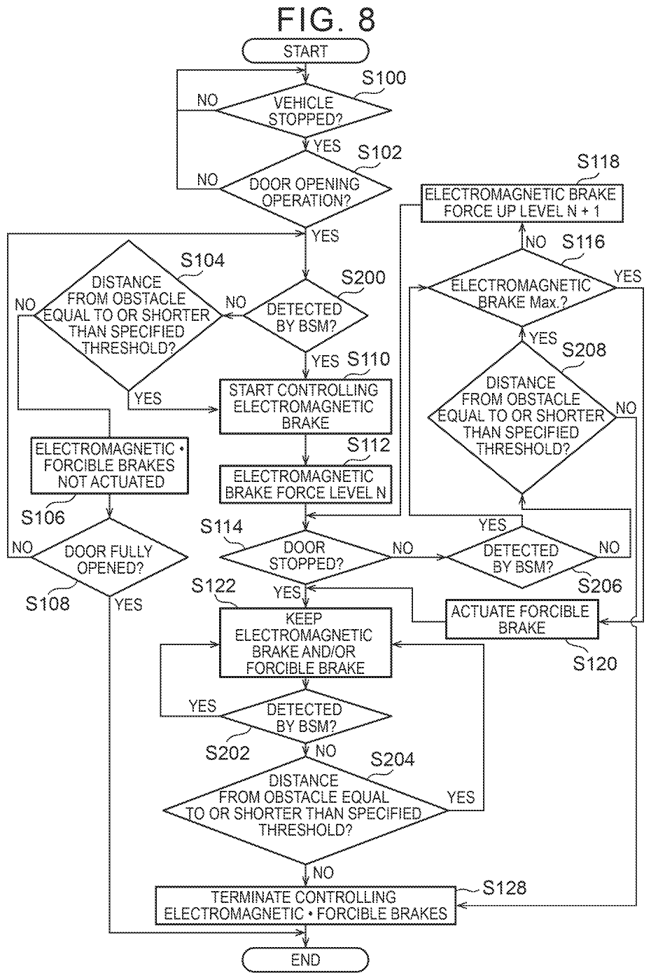

Next, a description will be provided on a vehicle door control device according to a second embodiment of the disclosure with reference to FIG. 8. Note that the same components as those in the above-described first embodiment and the like will be denoted by the same reference numerals and symbols and the description thereon will not be provided.

A vehicle door control device 60 according to this second embodiment has the same basic configuration as that in the first embodiment, and has a characteristic that the vehicle door control device 60 further detects an obstacle that approaches the vehicle 12 from behind (in other words, the vehicle door control device 60 detects obstacles including an obstacle that approaches the vehicle 12 from behind).

More specifically, as illustrated in FIG. 5, the vehicle door control device 60 includes the electromagnetic brake device 16, the forcible brake device 18, a surrounding detection sensor 62 as the obstacle detection unit, and the control unit 22, which are mounted on the vehicle 12 (see FIG. 1). The components are connected to each other via the bus 24 such that the components can communicate with each other.

The surrounding detection sensor 62 is a sensor that detects the surrounding situation around the vehicle 12, and is configured by combining an existing blind spot monitor (hereinafter simply referred to as “BSM”) system with a plurality of sensors. More specifically, the surrounding detection sensor 62 further detects, for example, an obstacle that approaches the vehicle 12 from behind and is located on an obliquely rear side at a blind spot of a rearview mirror, and an obstacle that approaches the vehicle 12 so as to cross an area behind the vehicle 12 (e.g., an obstacle that approaches the vehicle 12 in a direction orthogonal to an area behind the vehicle 12).

As illustrated in FIG. 6, the vehicle door control device 60 includes, as a functional configuration, an obstacle detection portion 66, the determination unit 52, and the output unit 54. The functional configuration is realized when the door opening-closing control program, which is stored in the ROM 42 or the storage 46 (see FIG. 5) is read and executed by the CPU 40 in the control unit 22.

The obstacle detection portion 66 receives information on the surrounding situation around the vehicle 12 from the surrounding detection sensor 62 and determines the presence or the absence, the kind, the position, and the like of an obstacle around the vehicle 12, in particular, an obstacle that exists on the opening-closing locus of the door 28, which is registered in advance, an obstacle that approaches the vehicle 12 from behind, and the like.

Next, a description will be provided on the operation of the vehicle door control device 60. FIG. 8 is a flowchart illustrating an operation procedure of the vehicle door control device 60. When the CPU 40 reads the door opening-closing control program from the ROM 42 or the storage 46, loads the door opening-closing control program into the RAM 44, and executes the door opening-closing control program, the opening-closing control for the door 28 is executed. Note that the same processing as that in the first embodiment will be denoted by the same reference numerals and symbols and the description thereon will not be provided.

When the opening operation of the door 28 is performed in step S102 (step S102: YES), the CPU 40 determines whether an obstacle is detected by the BSM (step S200). When an obstacle is detected by the BSM (step S200: YES), the CPU 40 performs the processing in step S110. On the other hand, when an obstacle is not detected by the BSM (step S200: NO), the CPU 40 performs the processing in step S104.

Next, when the door 28 is not stopped in step S114 (step S114: NO), the CPU 40 determines whether an obstacle is detected by the BSM (step S206). When an obstacle is detected by the BSM (step S206: YES), the CPU 40 performs the processing in step S116. On the other hand, when an obstacle is not detected by the BSM (step S206: NO), the CPU 40 detects the distance between the door 28 and an obstacle (i.e., an obstacle detected by a sensor other than the BSM), and determines whether the distance is equal to or shorter than the specified threshold (step S208).

When the distance between the door 28 and an obstacle is equal to or shorter than the specified threshold, that is, when an obstacle is located at the position near the door 28 and the opening-closing locus of the door 28 or at the position at which the obstacle interferes with the door 28 and the opening-closing locus of the door 28 (step S208: YES), the CPU 40 executes the processing in step S116. On the other hand, when the distance between the door 28 and an obstacle is longer than the specified threshold, that is, when an obstacle does not exist or when an obstacle is located at the position away from the door 28 and the opening-closing locus of the door 28 (step S208: NO), the CPU 40 executes the processing in step S128, that is, terminates the control processing.

After the CPU 40 keeps the operation of at least one of the electromagnetic brake device 16 and the forcible brake device 18, which is/are operated, in step S122, the CPU 40 determines whether an obstacle is detected by the BSM (step S202). When an obstacle is detected by the BSM (step S202: YES), the CPU 40 repeats the processing in step S122. On the other hand, when an obstacle is not detected by the BSM (step S202: NO), the CPU 40 detects the distance between the door 28 and an obstacle, and determines whether the distance is equal to or shorter than the specified threshold (step S204).

When the distance between the door 28 and an obstacle is equal to or shorter than the specified threshold, that is, when an obstacle is located at the position near the door 28 and the opening-closing locus of the door 28 or at the position at which the obstacle interferes with the door 28 and the opening-closing locus of the door 28 (step S204: YES), the CPU 40 executes the processing in step S122. On the other hand, when the distance between the door 28 and an obstacle is longer than the specified threshold, that is, when an obstacle does not exist or when an obstacle is located at the position away from the door 28 and the opening-closing locus of the door 28 (step S204: NO), the CPU 40 executes the processing in step S128, that is, terminates the control processing.

Next, a description will be provided on the operation and effects in the second embodiment.

Also, with the above configuration, the vehicle door control device 60 in the second embodiment is configured in the same manner as the vehicle door control device 10 in the first embodiment except that the vehicle door control device 60 further detects an obstacle that approaches the vehicle 12 from behind (i.e., the vehicle door control device 60 detects obstacles including an obstacle that approaches the vehicle 12 from behind). Thus, the same effects as those in the first embodiment can be obtained. In addition, the surrounding detection sensor 62 further detects an obstacle that approaches the vehicle 12 from behind. Thus, even in the case where the occupant opens the door 28 without noticing an obstacle that approaches the vehicle 12 from behind, it is possible to restrain the door 28 from coming into contact with the obstacle. Therefore, it is possible to further reliably prevent the door 28 from coming into contact with the obstacle at the time of opening-closing of the door 28.

Note that, in the above-described embodiment, the warning is not issued at the time when the operation of at least one of the electromagnetic brake device 16 and the forcible brake device 18, which is/are operated, is stopped. However, the second embodiment is not limited to this configuration. Similarly to the first embodiment, the warning may be issued in the second embodiment.

In addition, in the first and second embodiments described above, the braking force is increased stepwise when the electromagnetic brake device 16 is operated. However, the disclosure is not limited to this configuration. The braking force may be continuously increased or the braking force may be exerted discontinuously (i.e., in a non-continuous manner).

Furthermore, the forcible brake device 18 is configured that the forcible brake pin 18C is fitted to the locking hole 16CC of the rack gear 16C. However, the disclosure is not limited to this configuration, and another configuration may be adopted as long as opening-closing of the door 28 is mechanically stopped.

The description has been made so far on the embodiments of the disclosure. However, the disclosure is not limited to the above embodiments, and various modifications can be made within the scope of the disclosure.

What is claimed is:

1. A vehicle door control device comprising:
a door braking unit configured to brake opening-closing operation of a door in a vehicle;
a door forcibly stopping unit configured to forcibly and mechanically stop the opening-closing operation of the door,
an obstacle detection unit configured to detect an obstacle that exists around the vehicle or approaches the vehicle; and
a control unit configured to operate the door braking unit and further operate the door forcibly stopping unit according to a status of the opening-closing operation of the door when the obstacle detection unit detects the obstacle.

2. The vehicle door control device according to claim 1, wherein the control unit is configured to operate the door braking unit such that a braking force is gradually increased as a distance between the door and the obstacle is decreased when the door is opened.

3. The vehicle door control device according to claim 2, wherein the control unit is configured to increase the braking force of the door braking unit stepwise.

4. The vehicle door control device according to claim 1, wherein the control unit is configured to operate the door forcibly stopping unit in a case where opening-closing of the door is not stopped in a state where a braking force of the door braking unit is at a maximum.

5. The vehicle door control device according to claim 1, wherein the obstacle detection unit is configured to further detect the obstacle that approaches the vehicle from behind.

6. The vehicle door control device according to claim 1, wherein the obstacle detection unit is configured to further detect the obstacle that exists on an opening-closing locus of the door.

7. The vehicle door control device according to claim 1, wherein after the control unit operates at least one of the door braking unit and the door forcibly stopping unit to stop the opening-closing operation of the door, the control unit stops operation of the at least one of the door braking unit and the door forcibly stopping unit after a lapse of a specified time since the opening-closing operation of the door is stopped.

8. The vehicle door control device according to claim 7, wherein the control unit is configured to operate a warning unit that issues a warning when stopping the operation of the at least one of the door braking unit and the door forcibly stopping unit.
